(19) United States
(12) Patent Application Publication
(10) Pub. No.: US 2008/0196911 A1
(43) Pub. Date: Aug. 21, 2008

(54) Hand Power Tool

(76) Inventors: Reiner Krapf, Reutlingen (DE); Michael Mahler, Leinfelden-Echterdingen (DE); Gunter Flinspach, Leonberg (DE); Hans Irion, Winnenden (DE)

Correspondence Address: MICHAEL J. STRIKER, 103 EAST NECK ROAD, HUNTINGTON, NY, 11743, US

(21) Appl. No.: 11/995,642

(22) PCT Filed: Oct. 13, 2006
(86) PCT No.: PCT/EP2006/067384

§ 371 Date: Jan. 14, 2008

(30) Foreign Application Priority Data
Oct. 14, 2005 (DE) 10 2005 049 130.8

(51) Int. Cl. B23Q 5/00

(52) U.S. Cl. 173/4

(57) ABSTRACT

The invention relates to a portable power tool with a control device comprising a control unit (12) and a sensor unit (14) for generating a distance signal. The invention provides that the control unit (12) designed for controlling at least one operating parameter of a tool carrying unit according to the distance signal.

### PRIOR ART

The invention is based on a hand power tool as generically defined by the preamble to claim 1.

Power drills with a device for determining a penetration depth of a drill into a workpiece are known. A device of this kind is typically embodied as a depth stop with a length scale. For determining or limiting the penetration depth, the drill and the depth stop are placed against the workpiece, and with the aid of the length scale a spacing of the hand power tool from the workpiece is determined. Next, the depth stop is displaced by a desired penetration depth, and the workpiece is machined by driving the drill inward to the desired penetration depth.

### ADVANTAGES OF THE INVENTION

The invention is based on a hand power tool, having a control system including a control unit and a sensor unit for generating a distance signal.

It is proposed that the control unit is provided for controlling at least one operating parameter of a tool insert support unit as a function of the distance signal. As a result, the operating parameter can be adapted to a tool insert used or to a material or a machining distance, in order—especially automatically—to achieve very good machining results without requiring special experience on the part of the user of the hand power tool. The control can be attained for instance by calculating the magnitude of the operating parameter as a function of the distance signal, or by selecting the magnitude from a one- or multi-dimensional data field. The hand power tool may be a saw, power sander, or angle grinder. Especially advantageously, the hand power tool is a power drill, since the optimal setting of a drill with regard to rotary speed and for instance impact is especially difficult for a nonprofessional, and automation offers especially pronounced advantages in the outcome of the work. The power drill may be embodied with or without an impact mechanism, as a rotary hammer, cordless drill, or cordless screwdriver or the like. A jigsaw, saber saw, angle grinder, or flooring tile saw, in all of which a plunging depth into a workpiece has to be settable, are also conceivable.

The sensor unit expediently includes a distance sensor. The distance can be ascertained optically, for instance by means of laser radiation and/or infrared radiation, or by means of ultrasound, or mechanically. Advantageously, the control unit is prepared for repeated and in particular continuous measurement of the distance during a work procedure. As a result, the operating parameter can be varied or adapted during a work procedure. The operating parameter is advantageously a work parameter, in which the tool insert support unit remains in motion, and the tool insert in particular that is carried by the tool insert support unit is intended for machining a workpiece. The tool insert support unit may be a spindle for receiving a drill, chisel or the like, or it may be a receptacle for a saw blade, a grinding wheel, a cutting wheel, or the like.

In an advantageous feature of the invention, the operating parameter is at least one parameter selected from the group comprising travel speed, impact intensity, impact frequency, pendulum stroke, maximum torque, and travel direction. If the operating parameter is a travel speed, then the travel speed of a tool insert can be reduced or reset to zero shortly before a set machining depth or distance is reached. It is equally conceivable to disengage the tool insert while a motor of the hand power tool continues to run and the tool insert for instance comes to a standstill. If the operating parameter is a pendulum stroke, then the machining speed of a saw blade, for instance, in the workpiece can be adapted to a desired machining speed, and quieter or faster work can be attained. If the operating parameter is an impact intensity or impact frequency, then the impact intensity or impact frequency can be increased—for instance if the drilling advancement is found insufficient. If the operating parameter is a maximum torque, then—particularly in a screwdriver—the torque before or upon reaching a desired screw-in depth is reduced, so that overscrewing of a screw in a workpiece is counteracted. Advantageously, the operating parameter is a travel direction. Especially if a known tool insert length is employed, the control system can tell automatically whether a user would like to insert the screw or unscrew it and can adjust the travel direction accordingly.

Advantageously, the control unit is provided for ascertaining a relative speed of the sensor unit to a workpiece. As a result, the operating parameter can be adapted such that an optimal progress of the work is attainable.

Preferably, the control unit is provided for varying the operating parameter as a function of the distance signal, while maintaining a work operation on a workpiece. Work progress found to be inadequate or overly fast can be optimized, and the operating parameter can be improved as a result without having to disrupt the work procedure.

In a further variant embodiment of the invention, the control unit is provided for ascertaining tool insert data, as a function of the distance signal, and adapting the operating parameter to the tool insert data. From the ascertainment of the distance, for instance from the distance sensor to the workpiece, it is possible to draw a conclusion about the tool insert size, such as the size of a drill or a saw, and the motion of the tool insert can be adapted to the size of the tool insert. The ascertainment can be done by calculation or by a selection from predetermined data.

In a further embodiment, the control unit is provided for ascertaining material data, as a function of the distance signal, of a workpiece that reflects the distance signal and adapting the operating parameter to the material data. Thus, for instance if electromagnetic radiation is used as the distance signal, the phase of the reflected electromagnetic radiation can be ascertained, and from that a conclusion can be drawn as to whether the material is metal or nonmetal. By a suitable adaptation of the operating parameter, a good work outcome can be attained in a simple way.

The hand power tool can be produced especially inexpensively if the control unit has an optical sensor, for instance an infrared sensor. A distance from a workpiece can be ascertained by means of transit time measurement or with the aid of triangulation, by providing a transmitter and a receiver of the sensor unit at a known spacing from one another in the sensor unit.

Expediently, the distance signal is a high-frequency signal, in particular a radar signal. Because of the high frequency, a distance sensor can easily be integrated into a power drill, for instance, and embodied in compact form. For that purpose, the distance signal is advantageously at a frequency of over 70 GHz, and hence its antenna can be small. In addition, a distance sensor can be built into a power tool housing and thus kept invisible and protected against becoming soiled. Calibration and presetting can also be dispensed with, so that the distance sensor is easy to use and not vulnerable to malfunction. The hand power tool can be kept compact and invulnerable if the distance sensor is integrated on a radar chip that is provided for high-frequency generation and reception and raw signal processing. Additional further processing into a low-frequency signal on the radar chip itself is also advantageous.

Especially safe operation of the hand power tool can be attained if the control unit has safety-related data, which pertain to a spacing of an object, in particular a user, from a tool insert and for controlling the operating parameter as a function of the distance signal and of the safety-related data. Thus the control unit can for instance switch off the motion of a tool insert if a user comes too close to the tool insert, such as a circular saw. By means of an additional brake, accidents can be counteracted as a result. The operating parameter is expediently a motion parameter of the tool insert support unit.

It is furthermore proposed that the sensor unit has a plurality of sensors, and the control unit is provided for ascertaining an angular position of a tool insert relative to a workpiece. Skewed drilling can be indicated by a warning signal, for instance, and straight drilling can be made easier for the user.

By means of a distance data memory and a means for resetting data in the distance data memory, a work procedure distance, such as a drilling depth, can be monitored especially easily by a user. The resetting can be done manually or automatically. Automatic resetting, for instance at the beginning of a machining operation such as drilling, is especially advantageous, since it can then be assumed that the tool insert, such as a drill, is in contact with the workpiece at the beginning of the machining operation.

Easy operation of the hand power tool can be attained if the hand power tool includes an output unit, the control unit being provided for displaying a work parameter by means of the output unit. The work parameter can be a drilling depth that has been set or is attained, or a working distance that has been set or traversed. Advantageous examples of work parameters are also material data, a set or desired operating mode, tool insert data, and/or at least one operating parameter. A display can be done visually, for instance alphanumerically, or as a light signal, or as an acoustical signal. With the same advantage, the hand power tool includes a user control panel for inputting a work parameter.

### DRAWINGS

Further advantages will become apparent from the ensuing description of the drawings. In the drawings, exemplary embodiments of the invention are shown. The drawings, description and claims include numerous characteristics in combination. One skilled in the art will expediently consider the characteristics individually as well and put them together to make useful further combinations.

Shown are:

FIG. 1, a power drill in a schematic view from the side and from the front;

FIGS. 2a-2d, front views of power drills with various arrangements of distance sensors;

FIGS. 3a-3c, three display devices;

FIG. 4, a power drill with a dowel on a wall, from the side and from behind;

FIG. 5, the power drill of FIG. 4 directly at the wall;

FIG. 6, a further power drill, from the side and from behind;

FIG. 7, a jigsaw schematically shown from the side and from above;

FIG. 8, a circular power saw mounted in stationary fashion; and

FIG. 9, a cordless screwdriver, from the side and from behind.

### DESCRIPTION OF THE EXEMPLARY EMBODIMENTS

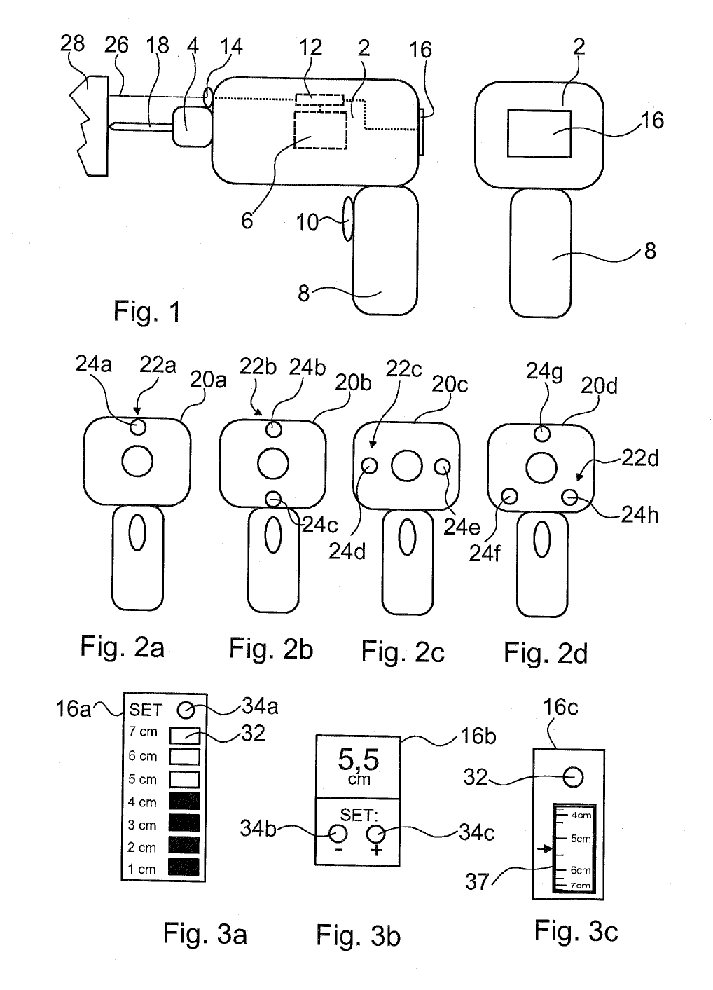

FIG. 1 shows a hand power tool, embodied as a power drill 2, in a schematic view from the side and from behind. The power drill 2 includes a tool insert support unit in the form of a spindle 4, which can be driven by a motor 6; a handle 8 with an actuation button 10; and a control unit 12 for controlling the motor 6, which is connected to a sensor unit 14 and to an output unit, embodied as a display means 16, with a liquid crystal display. A tool insert 18 in the form of a drill is secured in the spindle 4. The principle shown in FIG. 1 is at least essentially applicable to all the hand power tools shown in the drawings.

In FIGS. 2a-2d, four different hand power tools, embodied as power drills 20a-20d, are shown from the front in a schematic view. The power drills 20a-20d each include a respective sensor unit 22a-22d, each with one or more sensors 24a-24h. The power drill 20a includes only one sensor 24a for measuring a distance 26 between the sensor 24a and a workpiece 28. By using two sensors 24b, 24c and 24d, 24e as in the power drill 20b in FIG. 2b and the power drill 20c in FIG. 2c, respectively, tilting of the power drill 20b, 20c in or transversely to a grip direction relative to the workpiece 28 can be detected by means of a different spacing of the various sensors 24b, 24c and 24d, 24e from the workpiece 28. With three sensors 24f-24h as in FIG. 2d, or more sensors than three, tilting of the power drill 20d longitudinally and transversely to the grip direction can be detected, and exactly perpendicular drilling into the workpiece 28 can be made easier for a user.

FIGS. 3a and 3b show two different display means 16a, 16b for use in an arrangement as shown for instance in FIG. 1. The display means 16a displays a distance 26, for instance from the sensor unit 14 to the workpiece 28, or a change in the distance, with the aid of seven LEDs 32, which light up or not depending on the distance 26 or the change in the distance. By means of a user control panel, for instance in the form of a button 34a, the display means 16a can be reset to zero, for instance when a tip of the tool insert 18 is in contact with the workpiece 28. If in a work procedure the tool insert 18 is now driven into the workpiece 28, the distance traveled by the sensor unit 14 from the resetting position of the display means 16a relative to the workpiece 28 is indicated in increments of 1 cm.

In the display means 16b of FIG. 3b, the distance display is numerical, in increments of 0.1 cm. For resetting the distance display, hereinafter also called zeroizing, the display means 16 includes two buttons 34b, c. When both buttons 34b, c are pressed simultaneously, the distance display is reset to zero. For setting a desired drilling depth, the buttons 34b, c are used separately, until the desired drilling depth is displayed. Next, the tool insert 18 can be placed against the workpiece 28, and the actuation button 10 can be pressed, so that the motor 6 starts up and the tool insert 18 moves. Pressing the actuation button 10 causes the display means 16b to be automatically reset to zero by the control unit 12, and the working distance traversed by the tool insert 18 in the workpiece 28 is displayed. Once the working distance reaches the preset value, the motor 6 is automatically shut off by the control unit 12. Decoupling the spindle 4 in an idling mode, or an acoustical signal or optical display on the display means 16b is alternatively possible; for instance, the number displayed can begin to blink.

The display means 16c of FIG. 3c has a rotation regulator 37 and an LED 32. Distances 26 are printed on the rotation regulator 37 and can easily be set. When the distance 16 is reached, the LED 32 lights up or the motor 6 is shut off.

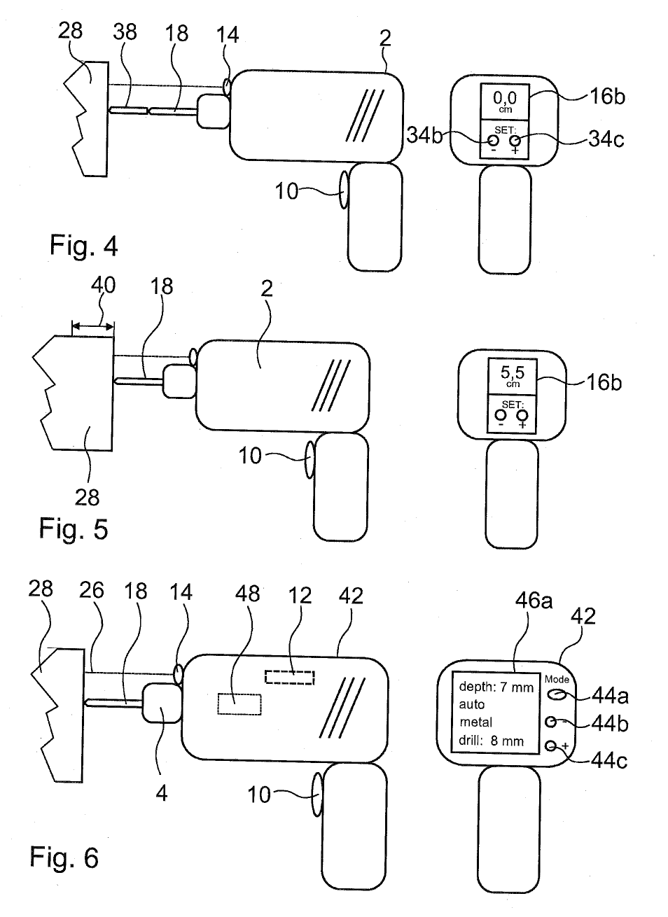

An alternative method of presetting a drilling depth will now be described in conjunction with FIGS. 4 and 5. A dowel 38, as shown in FIG. 4, is placed against the workpiece 28, for instance a well. The tool insert 18 is now placed against the dowel 38, and both buttons 34b, 34c are pressed simultaneously, causing the display means 16b to be reset to zero, as shown in FIG. 4. The control unit 12 includes a distance data memory, and simultaneously pressing both buttons 34b, 34c resets the data in the distance data memory. Next, the dowel 38 is removed, and the tool insert 18 is placed directly against the workpiece 28, as shown in FIG. 4. The sensor unit 14 is brought closer to the workpiece 28 in this process by the length of the dowel 38, for instance 5.5 cm. This change in distance is displayed on the display means 16b. The actuation button 10 can now be pressed, causing the display means 16b to be reset to zero and causing the tool insert 18 to be driven into the workpiece 28. Once the preset value, for instance of 5.5 cm, is reached, a drilling depth 40, is precisely equivalent to the length of the dowel 38. The work procedure is discontinued by means of an automatic reaction of the control unit 12, or the attainment of the work objective is indicated acoustically or displayed visually.

FIG. 6 shows a further hand power tool, embodied as a power drill 42. Components that remain essentially the same are identified by the same reference numerals throughout. Moreover, with regard to characteristics and functions that remain the same, the description of the exemplary embodiments of FIGS. 1-5 can be referred to. The ensuing description is limited essentially to the differences from the exemplary embodiments of FIGS. 1-5. The power drill 42 can be operated in a plurality of modes, which can be selected with the aid of a setting means in the form of a button 44a. The mode selected is displayed on a display means 46a; in FIG. 6, an automatic mode is indicated by the display “auto”. By means of buttons 44b, 44c, a desired drilling depth can be set, which is likewise displayed on the display means 46a. Alternatively, the selection method described in conjunction with FIGS. 4 and 5 can be used to select a drilling depth. Now—once the tool insert 18 has been secured in the spindle 4—the tool insert 18 is placed against the workpiece 28, and the actuation button 10 is pressed. By means of the sensor unit 14 in conjunction with the control unit 12, the distance 26 of the sensor unit 14 from the workpiece 28 is measured. For this purpose, the sensor unit 14 has a high-frequency emitter, for instance a radar emitter. The radar emitter is part of a compact component in the form of a radar chip, with integrated evaluation electronics. From the distance 26, the control unit 12 automatically draws a conclusion about the type of tool insert 18, namely its thickness. This conclusion is drawn in the control unit 12 on the basis of a data field in which drill lengths are associated with drill thicknesses. The drill length can be ascertained from the distance 26 and a known position of a stop for the tool insert 18 inside the spindle 4. The drill thickness is now also displayed on the display means 46a, and in the example of FIG. 6 it is 8 mm. Alternatively, the drill thickness can be ascertained by means of an additional sensor, located for instance in the drill chuck. The distance signal reflected by the workpiece 28 is received by the sensor unit 14 and examined for its phase in proportion to the distance 26. From this proportion, the control unit ascertains a phase jump of the distance signal in the workpiece 28, and from that draws a conclusion about the material comprising the workpiece 28, such as metal. The outcome of this ascertainment is also displayed on the display means 46a.

An optimal drilling mode is now calculated by the control unit 12; the material comprising the workpiece 28 and the drill thickness are included in the calculation. As the result, an optimal rpm is specified as the operating parameter, with which the spindle 4 and thus the tool insert 18 are driven by the motor 6. As a further operating parameter, a maximum torque above which a safety coupling 48 disengages and discontinues the transmission of force from the motor 6 to the spindle 4 is specified. In this way, breakage of the tool insert 18 can be prevented. The operating parameters may also be displayed on the display means 46a, for instance as additional information or as information that can be called up separately, for instance by actuating the button 44a. The progress of drilling of the tool insert 18 into the workpiece 28 is indicated by a decreasing drilling depth on the display means 46a, so that a user always knows how much farther he is supposed to be drilling. Once the desired drilling depth is reached, the tool insert 18 is disengaged by the safety coupling 48, and the motor 6 is slowly stopped by the control unit 12.

If a hard material, such as stone, is detected as the workpiece 28 by the control unit 12 from the distance signal, then as an additional operating parameter, an impact intensity and/or impact frequency is adapted to the tool insert 18 by the control unit 12. In addition, the speed of the progress of drilling, or in other words how fast the drill penetrates the workpiece 28, is detected by the control unit, and the impact intensity is varied as needed; it is increased if the drilling progress is too slow, and decreased if the drilling progress, for instance into brick, is very fast.

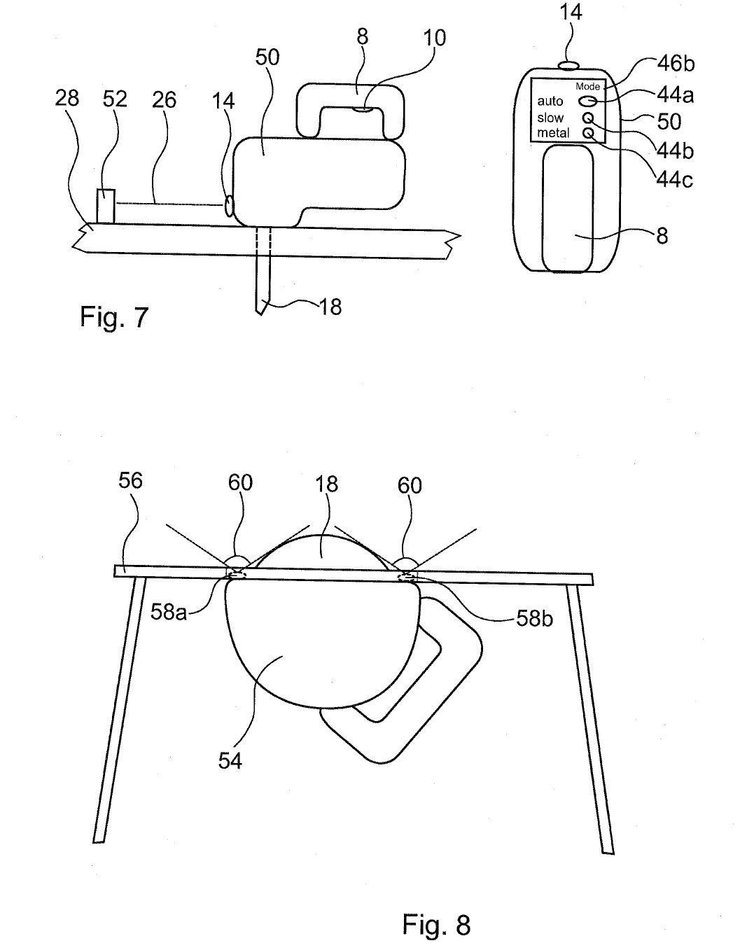

FIG. 7 shows a jigsaw 50 in a perspective view from the side and from above. The jigsaw 50 includes a tool insert 18, embodied as a jigsaw blade; a handle 8; and a sensor unit 14 and control elements connected to it, as described for the preceding drawings. On a display means 46b of the jigsaw 50, an operating mode can be set by means of the button 44a; in FIG. 7, it is an automatic mode. In addition, with the aid of the button 44b, a desired working speed can be selected: slow, medium, or fast. This speed is also displayed on the display means 46b. With the aid of the button 44c, the material comprising the workpiece 28 to be machined can be selected. Alternatively, the material is automatically ascertained from the distance signal. After the actuation button 10 is pressed, the distance 26 from the sensor unit 14 to a measuring element 52, which a user has connected to the workpiece 28, is permanently measured and from that a work speed of the tool insert 18 in the workpiece 28 is ascertained. It is also possible for the sensor unit 14 to be embodied as Doppler radar, for directly determining the work progress of the tool insert 18 in the workpiece 18. From the work progress, the workpiece material, and the desired work progress, an optimal pendulum stroke is ascertained by the control unit 12, and the tool insert 18 is controlled accordingly; as a result, a good outcome of the work can be attained, such as a clean cut in the workpiece 28.

FIG. 8 shows a hand power tool embodied as a circular power saw 54, which is secured to a workbench 56 and used as a circular table saw. The circular power saw 54 includes two sensors 58a, 58b, each with a monitoring range 60 shown in FIG. 8. If any object whatever moves within the monitoring range 60 at a speed that exceeds a safety value stored in memory in the control unit 12 of the circular power saw 54, then the tool insert 18, embodied as a circular saw blade, is immediately stopped with the aid of a brake. If an object moves away from the tool insert 18 at a speed that exceeds a second safety value of the control unit 12, then once again the tool insert 18 is immediately stopped. The second safety value is substantially greater than the first safety value, so that if the motion away from a workpiece is speedy the circular saw blade continues to run, but it stops abruptly if a user's hand, for instance, is jerked back.

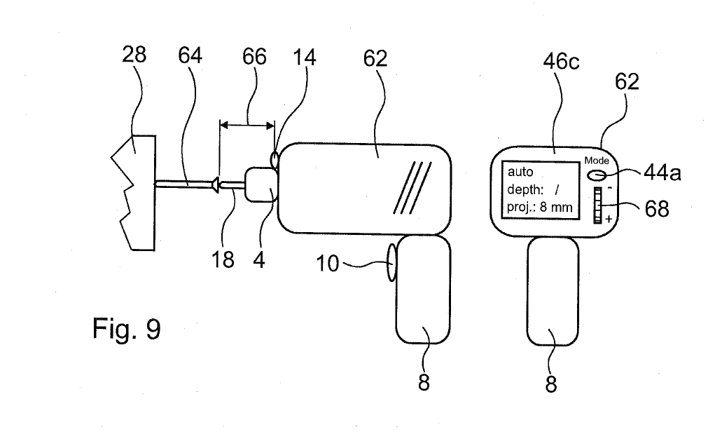

FIG. 9 shows a cordless screwdriver 62 in a schematic view from the side and from behind. A tool insert 18 in the form of a screwdriver bit is secured in the spindle 4 of the cordless screwdriver 62. For screwing a screw 64 into the workpiece 28, then first, with the aid of the button 44a of a display means 46c, an operating mode of the cordless screwdriver 62 can be selected, such as the automatic mode, as shown in FIG. 9. With the aid of knurled wheel 68, it can now be ascertained how deeply the screw 64 should be screwed into the workpiece 28. The displayed depth is shown on the display means 46c, and the screw 64 can be screwed to the desired depth into the workpiece 28—in a manner analogously to that described in conjunction with FIG. 6. In another operating mode, the distance that the screw 64 should protrude from the workpiece 28 is set; in FIG. 9, 8 mm is indicated. To that end, the tool insert 18 is inserted for instance into a gauge that is provided with a screw slit, and the actuation button 10 is briefly actuated. The control unit, in conjunction with the sensor unit 14, now calculates the distance 26 from the gauge, which corresponds to a spacing 66 from the head of the screw 64. The screw 64 can now be screwed into the workpiece 28, and the distance 26 between the sensor unit 14 and the workpiece 28 is permanently monitored. Once this distance 26 reaches the spacing 66, plus the set distance of 8 mm, then the spindle 4 is automatically decoupled by the control unit 12, and the motor 6 is brought to a stop.

If the screw 64 has already been screwed into the workpiece 28, then the control unit 12, from the distance 26, detects the slight protrusion of the screw 64 from the workpiece 28 and automatically determines the direction of rotation of the screwdriver bit such that the screw 64 is unscrewed when the actuation button 10 is pressed. In this way, the direction of rotation of the screwdriver bit is automatically set by the control unit 12 as a function of the distance signal.

1. A hand power tool, having a control system including a control unit (12) and a sensor unit (14) for generating a distance signal,
characterized in that the control unit (12) is provided for controlling at least one operating parameter of a tool insert support unit as a function of the distance signal.

2. The hand power tool as defined by claim 1,
characterized in that the operating parameter is at least one parameter selected from the group comprising travel speed, impact intensity, impact frequency, pendulum stroke, maximum torque, and travel direction.

3. The hand power tool as defined by claim 1,
characterized in that the control unit (12) is provided for varying the operating parameter as a function of the distance signal, while maintaining a work operation on a workpiece (28).

4. The hand power tool as defined by claim 1, characterized in that the control unit (12) is provided for ascertaining tool insert data, as a function of the distance signal, and adapting the operating parameter to the tool insert data.

5. The hand power tool as defined by claim 1, characterized in that the control unit (12) is provided for ascertaining material data, as a function of the distance signal, of a workpiece (28) that reflects the distance signal and adapting the operating parameter to the material data.

6. The hand power tool as defined by claim 1, characterized in that the distance signal is a high-frequency signal, in particular a radar signal.

7. The hand power tool as defined by claim 1, characterized in that the control unit (12) has safety-related data, which pertain to a spacing of an object, in particular a user, from a tool insert (18) and for controlling the operating parameter as a function of the distance signal and of the safety-related data.

8. The hand power tool as defined by claim 1, characterized in that the sensor unit (14) has a plurality of sensors (24a-h), and the control unit (12) is provided for ascertaining an angular position of a tool insert (18) relative to a workpiece (28).

9. The hand power tool as defined by claim 1, characterized by a distance data memory and a means for resetting data in the distance data memory.

10. The hand power tool as defined by claim 1, characterized by an output unit, the control unit being provided for displaying a work parameter by means of the output unit.

11. The hand power tool as defined by claim 1, characterized by a user control panel for inputting a work parameter.
